(19) United States
(12) Patent Application Publication
(10) Pub. No.: US 2009/0322670 A1
(43) Pub. Date: Dec. 31, 2009

(54) Color bistable display

(76) Inventors: Achintya Bhowmik, Milpitas, CA (US); Damitri E. Nikonov, Morgan Hill, CA (US)

Correspondence Address: INTEL CORPORATION;c/o CPA Global, P.O. BOX 52050, MINNEAPOLIS, MN, 55402, US

(21) Appl. No.: 12/217,090

(22) Filed: Jun. 30, 2008

(51) Int. Cl. G09G 3/34

(52) U.S. Cl. 345/107

(57) ABSTRACT

A capsule for a color display includes an outer shell (110, 331, 431) surrounding an interior space (120), a solution (130) containing quantum dots (140) within the interior space, and pigment particles (150) suspended in the solution. In one embodiment, the quantum dots have a first electric charge with a first polarity and the pigment particles have a second electric charge with a second polarity that is opposite the first polarity.

### FIELD OF THE INVENTION

The disclosed embodiments of the invention relate generally to color displays, and relate more particularly to color displays containing quantum dots.

### BACKGROUND OF THE INVENTION

Laptops and other portable and handheld electronic devices with graphics capabilities are becoming increasingly popular, with mobile Internet access, electronic book readers, and other graphics-intensive activities and devices spurring customer demand. Bistable electrophoretic (EP) displays represent a promising technology for such devices. For the applications for which such devices are likely to be used, low power is a primary factor and therefore the frame refresh rate can be sacrificed. EP displays have a longer response time than some other display technologies but, advantageously, do not use any power when they are not switched. They work in reflected light and can also be used with back-lighting. They have less contrast than cathode ray tube (CRT) or liquid crystal displays (LCDs), but, unlike those displays, can be viewed in outside light.

The operation of EP displays is based the application of a voltage between electrodes in order to cause movement of reflective or absorbing particles inside of a screen. Both black and white and color displays are possible, but color displays using existing technology require the placement of color filters in front of separate pixels. Not only do color filters absorb at least one third of the reflected light, potentially resulting in poor visibility and poor contrast ratio, but they are also extremely expensive to implement.

### BRIEF DESCRIPTION OF THE DRAWINGS

The disclosed embodiments will be better understood from a reading of the following detailed description, taken in conjunction with the accompanying figures in the drawings in which:

FIGS. 1 and 2 are schematic representations of capsules for a color display according to various embodiments of the invention;

FIGS. 3-5 are schematic representations of color displays according to various embodiments of the invention; and

FIG. 6 is a flowchart illustrating a method of producing a color image according to an embodiment of the invention.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements, while similar reference numerals may, but do not necessarily, denote similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

### DETAILED DESCRIPTION OF THE DRAWINGS

In one embodiment of the invention, a capsule for a color display comprises an outer shell surrounding an interior space, a solution containing quantum dots within the interior space, and pigment particles suspended in the solution. The quantum dots have a first electric charge with a first polarity and the pigment particles have a second electric charge with a second polarity opposite the first polarity.

Embodiments of the invention enable the manufacture of a color display that does not require the use of color filters but that instead uses three types of color ink made of quantum dots. The color is determined by the resonant wavelength of transitions in the quantum dots, as detailed below. Outside the resonant transitions the quantum dots are highly reflective, enabling a color display having much higher brightness and much better contrast ratios than what are possible using existing technology.

Quantum dots absorb light only in a part of visible spectrum, while reflecting light of other wavelengths. As mentioned, they also provide a strong absorption coefficient at their resonant peak. Therefore the reflectance of the display will be higher (white will be whiter), and the off state intensity will be lower (black is blacker, and the colors are more saturated). The following calculations establish that a layer of quantum dots having a thickness of only a few micrometers (hereinafter “microns” or “μm”) is enough to produce complete absorption of the resonant wavelength of light. An advantage of the quantum dot display is that bright, high-contrast color is obtained without the need for additional elements beyond those required for a black and white display for a cost that is much lower than that required for the existing displays using color filters.

The relationship between the size of the quantum dot and the energy of the optical transition, which in turn determines the resonant wavelength, may be expressed as shown below in Equation 1.

$$E = {E}_{g} + \frac{3 {π}^{2} {ℏ}^{2}}{{a}^{2}} ( \frac{1}{{m}_{e}} + \frac{1}{{m}_{h}} ) \qquad [ Equation 1 ]$$

For the case of gallium arsenide (GaAs), the bulk bandgap energy E_{g}=1.42 eV. Given electron and hole masses of mₑ=0.067m₀ and mₕ=0.38 m₀, respectively, one can see that a diameter a=6 nanometers (nm) is enough to reach the resonant transition E=2.48 eV corresponding to light with a wavelength of 500 nm (seen as green in color). Other quantum dot diameters result in different colors.

The absorption coefficient is given by Equation 2, below,

$$α = \frac{{q}^{2} ℏ}{n {ɛ}_{0} {cm}_{0}^{2}} \frac{{M}^{2}}{{Ea}^{3} Δ E} , \qquad [ Equation 2 ]$$

where the momentum transition matrix element M²m₀=14 eV, refractive index n=3.62, and inhomogeneous broadening of the transition (due to size variation) ΔE=0.3 eV. Then, for 6 nm quantum dots, α=2·10⁵/m, which means that a quantum dot layer of just 15 μm or so will ensure a complete absorption near the resonant wavelength. More generally, (taking into account quantum dots of various sizes), the foregoing calculations reveal that an optimum thickness for a quantum dot layer according to one embodiment of the invention is between approximately 10 and approximately 20 microns.

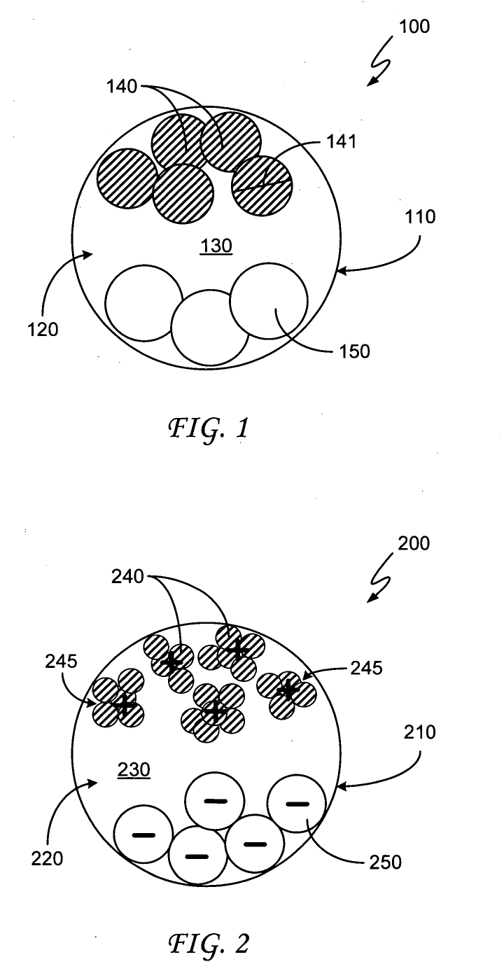

Referring now to the drawings, FIG. 1 is a schematic representation of a capsule 100 for a color display according to an embodiment of the invention. As illustrated in FIG. 1, capsule 100 comprises an outer shell 110 surrounding an interior space 120. A solution 130 with quantum dots 140 and pigment particles 150 suspended therein is located within interior space 120. As an example, solution 130 may comprise a transparent and non-polar organic liquid. As a particular example, solution 130 may comprise a substance form the alkane family such as benzene, hexane, toluene, or the like.

Quantum dots 140 have a first electric charge with a first polarity and pigment particles 150 have a second electric charge with a second polarity opposite the first polarity. In other words, either quantum dots 140 have a positive electric charge and pigment particles 150 have a negative electric charge, or quantum dots 140 have a negative electric charge and pigment particles 150 have a positive electric charge. The electric charges could be imparted, for example, by grouping cations or anions with quantum dots 140 and/or with pigment particles 150 in order to render the quantum dots or the pigment particles positively or negatively charged.

Being supplied with electric charges as described above, quantum dots 140 and pigment particles 150 may be attracted or repelled under the impetus of an electric field created by an externally-applied voltage. As an example, if a particular color is needed for an image to be shown on the color display, quantum dots 140 of the appropriate kind (e.g., having the appropriate diameter) may be moved (whether by attraction or repulsion, depending on the particular polarity of the charges and on the characteristics of the applied voltage) to a particular position within capsules 100 where they are visible to a viewer, while pigment particles 150 are similarly moved to a different position within capsule 100 where they are not visible to the viewer.

As a particular example, if a particular capsule is to appear white, white pigment particles 150 may be moved to an upper portion of the capsule closest to the viewer while the colored quantum dots 140 are moved in the opposite direction to a lower portion of the capsule that is farther from the viewer. A person looking at that particular capsule then sees only the white pigment particles and therefore the capsule appears to be white. Similarly, if a capsule or portion of a capsule is to appear green, quantum dots 6 nm in diameter (for GaAs; diameters for other quantum dot materials will differ) may be moved to the portion of the capsule while the pigment particles are moved away from the portion of the capsule. In summary, by causing movement of pigment particles and quantum dots of various diameters, any discernible visible color may be displayed.

As an example, capsule 100 may be made of an optically transparent, electrically non-conducting dielectric material such as any one of many different polymeric materials that are known in the art. The plastic may be formed into a hollow sphere, injected with solution 130 (containing quantum dots 140 and pigment particles 150), and sealed using techniques that are known in the art. As another example, quantum dots 140 can comprise a semiconducting material such as silicon, GaAs, cadmium selenide (CdSe), indium phosphide (InP), or virtually any other semiconducting material. In one embodiment, each one of quantum dots 140 comprises an element of a first species and an element of a second species, and in a particular manifestation of that embodiment, the element of the first species is a group II or a group III element and the element of the second species is a group V or a group VI element such that quantum dots 140 comprise a III-V or a II-VI semiconductor. Pigment particles 150 may comprise positively (or negatively) charged pigment chips made of, for example, titanium dioxide mixed with inorganic black pigment and polyethylene. In one embodiment, white pigment chips are used because of their high reflectivity over most of the visible spectrum.

As illustrated, a particular one of quantum dots 140 in solution 130 has a diameter 141. In one embodiment, all of quantum dots 140 have a diameter that is equal (or substantially equal) to diameter 141 such that all of quantum dots 140 within capsule 100 are substantially the same size. In a different embodiment, capsule 100 may contain quantum dots of two or more different sizes. In the same or another embodiment, quantum dots of two or more different kinds (i.e., two or more different semiconducting materials or combinations of semiconducting materials) may be introduced into a single capsule, a practice that may be appropriate for situations in which quantum dots of one kind work well for one wavelength while quantum dots of a different kind work well for a different wavelength.

As explained above, the resonant optical transitions of quantum dots, and thus their luminescence and reflectance peak, depends on the quantum dot diameter. Although luminescence is not used in at least certain embodiments of the present invention (both because of the greater amounts of power it would require and because luminescent displays are difficult to see outdoors in bright sunlight), luminescence is mentioned here as a way of highlighting the strong absorption properties of quantum dots 140, which absorption properties are related to luminescence in a well-known way (i.e., the peak of luminescence and of absorption are at the same points).

FIG. 2 is a schematic representation of a capsule 200 for a color display according to a different embodiment of the invention. As illustrated in FIG. 2, capsule 200 comprises an outer shell 210 surrounding an interior space 220. A solution 230 with quantum dots 240 and pigment particles 250 suspended therein is located within interior space 220. As an example, outer shell 210, interior space 220, solution 230, quantum dots 240, and pigment particles 250 can be similar to, respectively, outer shell 110, interior space 120, solution 130, quantum dots 140, and pigment particles 150, all of which are shown in FIG. 1. Quantum dots 240 are bunched together into aggregates 245 that each contain a plurality of quantum dots 240 and thus having a larger size than that of any individual quantum dot by itself. FIG. 2 depicts pigment particles 250 as having a negative polarity and aggregates 245 as having a positive polarity, but these polarities could of course be reversed.

As an example, aggregates 245 can be fabricated by mixing quantum dots 240 with a liquid polymer solution and then dispersing them to droplets of a desired size. In some embodiments, aggregates 245 may offer an advantage over individual quantum dots in terms of mobility. More specifically, the hydrodynamic drag is proportional to the size of aggregates 245, while the surface charge is proportional to the square of the size. As a result, the mobility of aggregates 245 may be larger than that of individual quantum dots 240, whose diameter is determined by optical properties and may not be large enough to achieve optimum mobility.

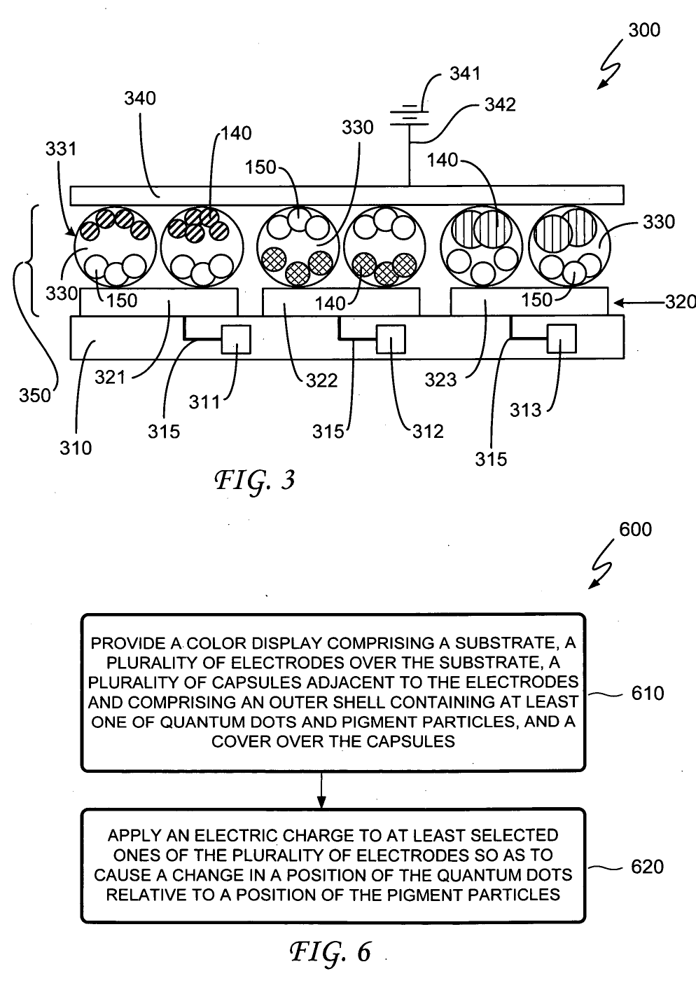

FIGS. 3-5 are schematic representations of color displays according to various embodiments of the invention. As illustrated in FIG. 3, a color display 300 comprises a substrate 310, a plurality of electrodes 320 over substrate 310, a plurality of capsules 330 adjacent to electrodes 320, and a cover 340 over capsules 330. In the illustrated embodiment, plurality of electrodes 320 comprises an electrode 321, an electrode 322, and an electrode 323. Capsules 330 comprise an outer shell 331 containing at least one of (or, as illustrated, both of) quantum dots 140 and pigment particles 150 suspended in a solution (not labeled in FIG. 3) that may be similar to solution 130 that is shown in FIG. 1. Outer shell 331 may be similar to outer shell 110. At least one of capsules 330 together with at least one of electrodes 320 forms a pixel 350 of color display 300. In one embodiment, cover 340 comprises a transparent or a translucent electrode, possibly comprising indium tin oxide (ITO) or the like. In the same or another embodiment, substrate 310 comprises an electronic board containing an electrically insulating material with embedded wires that carry an independent electrical signal to each (or at least some) of the adjacent electrodes. Accordingly, substrate 310 may comprise copper along with an appropriate insulating material to prevent unwanted electrical connections between the wires within substrate 310.

In one embodiment, a single electrode could be shared across two or more capsules and in the same or another embodiment there may be a plurality of electrodes for one pixel, such that the number of pixels within color display 300 is not necessarily the same as the number of electrodes or capsules within color display 300. More typically, and as illustrated in FIG. 3, pixel 350 consists of three electrodes (i.e., electrodes 321, 322, and 323) together with the capsules 330 associated with each of the three electrodes. FIG. 3 depicts an embodiment in which each electrode is associated with two capsules. In other embodiments, each electrode could be associated with a single electrode, multiple electrodes (i.e., two or more), or some fraction of an electrode (i.e., where a single capsule is associated with multiple electrodes).

Voltage sources 311, 312, and 313 may apply a voltage to, respectively, electrodes 321, 322, and 323 through wires 315 in substrate 310. Similarly, a voltage source 341 may supply a voltage to cover 340 through a wire 342. (Typically voltage source 341 is set at the ground (zero) value.) It should be understood that although voltages sources 311, 312, and 313 are depicted as being embedded in substrate 310, in other embodiments one or more of them could be located external to substrate 310.

In a particular embodiment, the capsules associated with electrode 321 each contain quantum dots 140 having a first diameter, the capsules associated with electrode 322 each contain quantum dots 140 having a second diameter, and the capsules associated with electrode 323 each contain quantum dots 140 having a third diameter. In the illustrated embodiment, the first diameter is smaller than the second diameter and the second diameter is smaller than the third diameter.

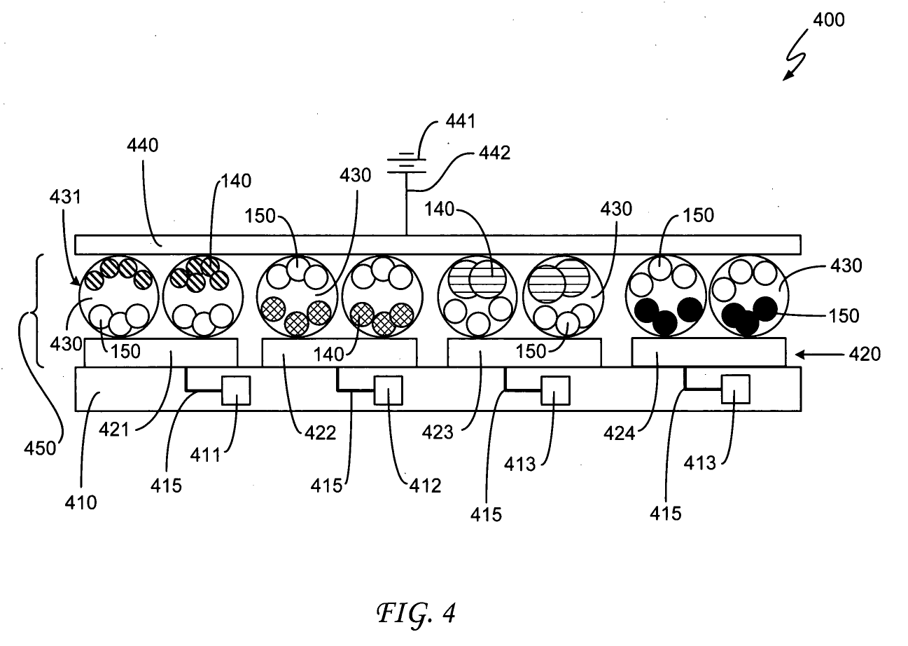

Referring now to FIG. 4, a color display 400 comprises a substrate 410, a plurality of electrodes 420 over substrate 410, a plurality of capsules 430 adjacent to electrodes 420, and a cover 440 over capsules 430. Substrate 410, electrodes 420, capsules 430, and cover 440 can be similar to, respectively, substrate 310, electrodes 320, capsules 330, and cover 340, all of which are shown in FIG. 3. At least one of capsules 430 together with at least one of electrodes 420 forms a pixel 450 of color display 400.

In the illustrated embodiment, plurality of electrodes 420 comprises an electrode 421, an electrode 422, an electrode 423, and an electrode 424. Capsules 430 comprise an outer shell 431 (that can be similar to outer shell 110 that is shown in FIG. 1) containing at least one of quantum dots 140 and pigment particles 150 suspended in a solution (not labeled in FIG. 4) that may be similar to solution 130 that is shown in FIG. 1. More specifically, in one embodiment electrodes 421, 422, and 423 may control capsules containing quantum dots corresponding to the three primary colors of the visible spectrum (in one embodiment these are red, green, and blue) while electrode 424 may control a capsule containing black and white color chips (i.e., pigment particles) similar to those used in a black and white display. A possible advantage of this embodiment is that it enables the brightness of pixel 450 to be controlled separately.

Voltage sources 411, 412, 413, and 414 may apply a voltage to, respectively, electrodes 421, 422, 423, and 424 through wires 415 in substrate 410. Similarly, a voltage source 441 may supply a voltage to cover 440 through a wire 442. (Typically voltage source 441 is set at the ground (zero) value.) It should be understood that although voltages sources 411, 412, 413, and 414 are depicted as being embedded in substrate 410, in other embodiments one or more of them could be located external to substrate 410.

In order to create a colored display one need use quantum dots of only three sizes, from which all discernible visible colors may be created according to well-known color mixing techniques. For CdSe quantum dots, for example, dot diameters of 1.5 nm, 4.5 nm, and 7.5 nm, for absorbing blue, green, and red, may be used. By filling the capsules in each pixel with quantum dots in these sizes (or corresponding sizes for other quantum dot materials), one can get access to any visible color.

It has already been mentioned herein that quantum dots absorb light only in a part of the visible spectrum while reflecting other wavelengths, and that they provide a strong absorption coefficient at their resonant peak. The foregoing discussion included certain equations from which one can conclude that a quantum dot layer just a few microns thick is enough to produce complete absorption of the resonant wavelength of light. These properties of quantum dots mean that the reflectance of a color display that incorporates quantum dots will be higher (e.g., white will be whiter), and the off state intensity will be lower (e.g., black will be blacker and the colors will be more saturated).

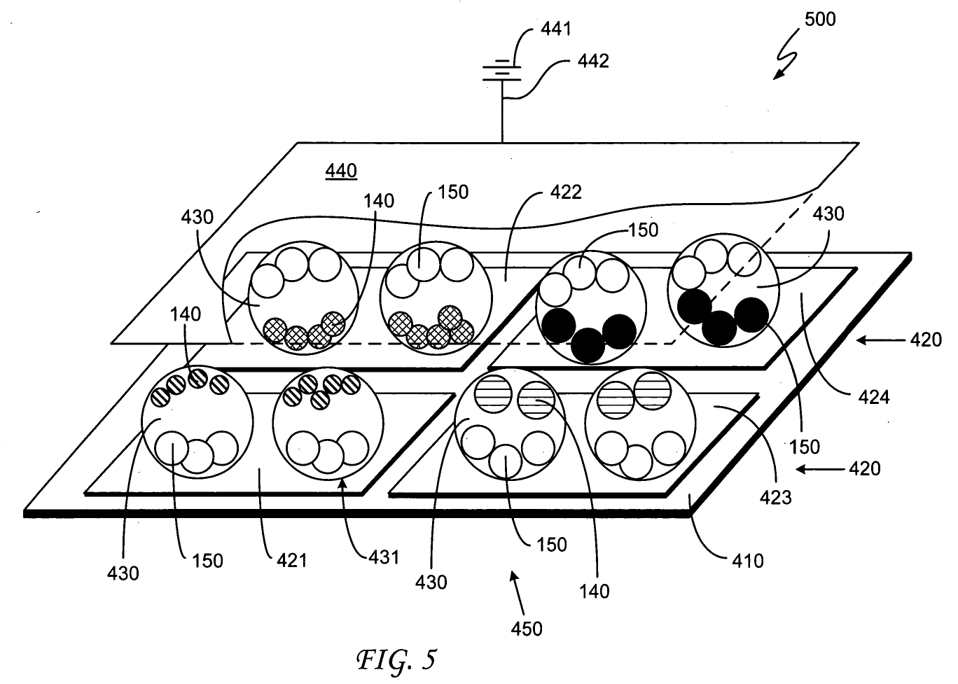

Referring now to FIG. 5, a color display 500 is similar to color display 400 but has a different configuration in which electrodes 421, 422, 423, and 424 are arranged in a double row pattern. Note that cover 440 is shown in a partially broken-away view so as to make visible the underlying capsules. Also, voltage sources 411, 412, 413, and 414 and wires 415 have been omitted from FIG. 5 in order to simplify the drawing.

FIG. 6 is a flowchart illustrating a method 600 of producing a color image according to an embodiment of the invention. As an example, the color image may be produced on a color display such as those illustrated in FIGS. 3 and 4 and used as electronic paper, handheld or mobile displays, secondary laptop screens, or the like. (Secondary displays for laptops are placed in certain laptop embodiments that do not require a fast refresh rate because they can consume little or no power without refresh. Secondary displays may also work in reflection mode and be used in outdoor lighting conditions where primary displays may lack sufficient brightness.)

A step 610 of method 600 is to provide a color display comprising a substrate, a plurality of electrodes over the substrate, a plurality of capsules adjacent to the electrodes and comprising an outer shell containing at least one of quantum dots and pigment particles, and a cover over the capsules. These components may be assembled using techniques that are known in the art. The resulting color display is a reflective rather than a luminescent color display, i.e., it is one that reflects incident light but does not emit light on its own. As an example, the substrate, the electrodes, the capsules, the quantum dots, the pigment particles, and the cover can be similar to, respectively, substrate 310, electrodes 320, capsules 330, quantum dots 140, pigment particles 150, and cover 340, all of which are shown in FIG. 3.

A step 620 of method 600 is to apply an electric charge to at least selected ones of the plurality of electrodes so as to cause a change in a position of the quantum dots relative to a position of the pigment particles. As has been described, this change in position could happen in any of several ways. For example, one could apply a positive electric charge to a first group of the capsules and a negative electric charge to a second group of the capsules, fill the positively-charged capsules with quantum dots and the negatively-charged capsules with pigment particles (or vice versa), then move the appropriate capsules toward the cover as required using either a repulsive or an attractive force. Another possibility would be to apply an electric charge to only one group of capsules, leaving the other group electrically neutral. Alternatively, one could fill the capsules with both quantum dots and pigment particles and then apply an electric charge to just one or the other of the dots and the pigment particles, leaving the other species electrically neutral, so as to enable the electrically-charged species within the capsules to be repelled or attracted as required. Another possibility involves applying an electric charge to both the quantum dots and the pigment particles so as to enable the simultaneous repulsion of one species and attraction of the other species within capsules using the externally-applied voltage.

It should be understood that the electric charge on a particular electrode need not necessarily be the same as the electric charge on a different electrode. In one embodiment, step 620 comprises creating a voltage difference between the electrodes and the cover. It should be understood that the voltage difference between a particular electrode and the cover need not necessarily be the same as the voltage difference between a different electrode and the cover.

In one embodiment, step 620 comprises electrically coupling a first wire to the cover and electrically coupling additional wires to the electrodes. As an example, the first wire can be similar to wire 342 (see FIG. 3) or wire 442 (see FIG. 4), while the additional wires, as suggested by the foregoing description, can be similar to wires 315 (FIG. 3) or 415 (FIG. 4). As another example, the additional wires may be run through the substrate, as illustrated in FIG. 3, where a first one of additional wires 315 is electrically coupled to electrode 321 of pixel 350, a second one of additional wires 315 is electrically coupled to electrode 322 of pixel 350, and a third one of additional wires 315 is electrically coupled to electrode 323 of pixel 350. FIG. 4 shows a similar configuration for color display 400 that further includes a fourth one of additional wires 415 electrically coupled to electrode 424 of pixel 450. Then, with wires configured as just described, a first voltage difference may be applied between the cover and the first electrode using the first wire and the first one of the additional wires, a second voltage difference may be applied between the cover and the second electrode using the first wire and the second one of the additional wires, and a third voltage difference may be applied between the cover and the third electrode using the first wire and the third one of the additional wires. Any discernible visible color may thus be achieved, as stated above.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the color displays and related structures and methods discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A capsule for a color display, the capsule comprising:
an outer shell surrounding an interior space;
a solution containing quantum dots within the interior space; and
pigment particles suspended in the solution,
wherein:
the quantum dots have a first electric charge with a first polarity; and
the pigment particles have a second electric charge with a second polarity opposite the first polarity.

2. The capsule of claim 1 wherein:
the pigment particles are reflective over substantially all of a visible portion of the electromagnetic spectrum.

3. The capsule of claim 1 wherein:
a first one of the quantum dots in the solution has a first diameter; and
each one of the quantum dots in the solution has a diameter that is substantially equal to the first diameter.

4. The capsule of claim 1 wherein:
each one of the quantum dots comprises an element of a first species and an element of a second species.

5. The capsule of claim 4 wherein:
the element of the first species is an element from group II or group III; and
the element of the second species is an element from group V or group VI.

6. A color display comprising:
a substrate;
a plurality of electrodes over the substrate;
a plurality of capsules adjacent to the electrodes, the capsules comprising an outer shell containing at least one of:
quantum dots; and
pigment particles; and
a cover over the capsules,
wherein:
at least one of the capsules together with at least one of the electrodes forms a pixel of the color display.

7. The color display of claim 6 wherein:
the quantum dots have a first electric charge with a first polarity and the pigment particles have a second electric charge with a second polarity opposite the first polarity.

8. The color display of claim 6 wherein:
the pixel comprises a first electrode with its associated capsules, a second electrode with its associated capsules, and a third electrode with its associated capsules.

9. The color display of claim 8 wherein:
the capsules associated with the first electrode each contain quantum dots having a first diameter;
the capsules associated with the second electrode each contain quantum dots having a second diameter; and
the capsules associated with the third electrode each contain quantum dots having a third diameter.

10. The color display of claim 9 wherein:
the quantum dots comprise cadmium selenide; and
the first diameter is substantially equal to 1.5 nm, the second diameter is substantially equal to 4.5 nm; and the third diameter is substantially equal to 7.5 nm.

11. The color display of claim 6 wherein:
the cover comprises a transparent electrode.

12. The color display of claim 6 wherein:
the pigment particles are reflective over substantially all of a visible portion of the electromagnetic spectrum.

13. The color display of claim 6 wherein:
each one of the quantum dots comprises an element of a first species and an element of a second species.

14. The color display of claim 13 wherein:
the element of the first species is an element from group II or group III; and
the element of the second species is an element from group V or group VI.

15. A method of producing a color image, the method comprising:
providing a color display comprising:
a substrate;
a plurality of electrodes over the substrate;
a plurality of capsules adjacent to the electrodes, the capsules comprising an outer shell containing at least one of quantum dots and pigment particles; and
a cover over the capsules; and
applying an electric charge to at least selected ones of the plurality of electrodes so as to cause a change in a position of the quantum dots relative to a position of the pigment particles.

16. The method of claim 15 further comprising:
causing the quantum dots to be electrically charged with a first electric charge having a first polarity; and
causing the pigment particles to be electrically charged with a second electric charge having a second polarity.

17. The method of claim 15 wherein:
applying the electric charge comprises creating a voltage difference between the electrodes and the cover.

18. The method of claim 17 wherein:
applying the electric charge comprises electrically coupling a first wire to the cover and electrically coupling additional wires to the electrodes.

19. The method of claim 18 further comprising:
grouping the electrodes into pixels, each pixel comprising three electrodes and their associated capsules;
electrically coupling a first one of the additional wires to a first electrode of a pixel; electrically coupling a second one of the additional wires to a second electrode of the pixel, and electrically coupling a third one of the additional wires to a third electrode of the pixel; and
applying a first voltage difference between the cover and the first electrode using the first wire and the first one of the additional wires, applying a second voltage difference between the cover and the second electrode using the first wire and the second one of the additional wires, and applying a third voltage difference between the cover and the third electrode using the first wire and the third one of the additional wires.

20. The method of claim 18 further comprising:
grouping the electrodes into pixels, each pixel comprising four electrodes and their associated capsules;
electrically coupling a first one of the additional wires to a first electrode of a pixel; electrically coupling a second one of the additional wires to a second electrode of the pixel, electrically coupling a third one of the additional wires to a third electrode of the pixel, and electrically coupling a fourth one of the additional wires to a fourth electrode of the pixel; and
applying a first voltage difference between the cover and the first electrode using the first wire and the first one of the additional wires, applying a second voltage difference between the cover and the second electrode using the first wire and the second one of the additional wires, applying a third voltage difference between the cover and the third electrode using the first wire and the third one of the additional wires, and applying a fourth voltage difference between the cover and the fourth electrode using the first wire and the fourth one of the additional wires.
